(19) United States
(12) Patent Application Publication
(10) Pub. No.: US 2006/0167652 A1
(43) Pub. Date: Jul. 27, 2006

(54) System for characterizing a signal

(76) Inventor: James R. Stimple, Santa Rosa, CA (US)

Correspondence Address: AGILENT TECHNOLOGIES, INC.;Intellectual Property Administration, Legal Department, DL 429, P.O. Box 7599, Loveland, CO, 80537-0599, US

(21) Appl. No.: 11/043,734

(22) Filed: Jan. 24, 2005

(51) Int. Cl. G06F 17/18

(52) U.S. Cl. 702/179

(57) ABSTRACT

A system characterizes a signal by determining an uncorrelated component of the signal that includes amplitude and timing fluctuations within the signal that are not correlated with a repetitive attribute of the signal, such as a repetitive bit pattern within the signal. The system also determines a correlated component of the signal that includes amplitude and timing fluctuations within the signal that are correlated with the repetitive attribute of the signal. A statistical model of the signal can be established that indicates fluctuations or deviations from the correlated component of the signal that are due to the uncorrelated component of the signal.

### BACKGROUND OF THE INVENTION

Signals in digital communication systems are typically characterized using digital communication analyzers (DCAs), bit error ratio testers (BERTs), and other types of sampling systems or signal analyzers. Presently available DCAs have a “jitter mode” of operation that applies pattern triggering to signals and then averages acquired samples of the signals to separate correlated and uncorrelated components of the timing fluctuations, or jitter, of the signals. Separating components of jitter that are correlated with bit patterns in the signal from components that are uncorrelated with the bit patterns enables designers of communication systems to determine causes of performance degradation of the systems. For example, correlated jitter, such as data dependent jitter (DDJ), can indicate sources of systematic errors in a communication system. Uncorrelated jitter can indicate presence of excessive noise at various locations in the communication system. Characterizing the jitter of a signal also enables the bit error ratio, or BER, that is attributable to the jitter on the signal to be determined.

While presently available DCAs typically characterize timing fluctuations of signals, such as jitter, characterizing amplitude fluctuations of signals can provide additional insight into the performance or design of a communication system and may enable BER that is attributable to both timing and amplitude fluctuations of the signal to be determined.

### SUMMARY OF THE INVENTION

A system according to embodiments of the present invention characterizes a signal by determining uncorrelated and correlated components of the signal. The uncorrelated component includes amplitude and timing fluctuations of the signal that are not correlated with a repetitive attribute of the signal, such as a repetitive bit pattern within the signal. The correlated component of the signal includes amplitude and timing fluctuations of the signal that are correlated with the repetitive attribute of the signal. The system also includes establishing a statistical model of the signal indicating fluctuations or deviations from the correlated component of the signal that are due to the uncorrelated component of the signal. The statistical model is typically established by applying to the correlated signal component of the signal, a three-dimensional probability density function that is based on the uncorrelated component of the signal. A bit error ratio (BER) that accounts for both amplitude and timing fluctuations of the signal can be determined at one or more designated amplitude and timing positions using the established statistical model. Contours of constant BER can also be established.

### BRIEF DESCRIPTION OF THE DRAWINGS

FIGS. 1A-1B show examples of sampling systems suitable for implementing a system for characterizing a signal according to embodiments of the present invention.

FIG. 2A shows one example of a signal that includes a repetitive bit pattern.

FIG. 2B shows one example of a detailed view of a transition within the example of the signal shown in FIG. 2A.

FIG. 2C shows examples of sets of acquired samples of the signal.

FIG. 3 shows a flow diagram of the system for characterizing a signal, according to embodiments of the present invention.

FIGS. 4A-4B show Fourier Transforms of corresponding sets of acquired samples of the signal.

FIGS. 5A-5B show probability density functions of corresponding sets of acquired samples of the signal.

FIG. 6 shows one example of a display of a family of averaged eye traces of the signal.

FIG. 7 shows one example of a three-dimensional probability density function suitable for establishing a statistical model of the signal according to embodiments of the present invention.

FIGS. 8A-8G illustrate features of one example of a method for determining bit error ratio (BER) according to alternative embodiments of the present invention.

FIG. 9 shows one example of a contour of constant BER established according to embodiments of the present invention.

### DETAILED DESCRIPTION OF THE EMBODIMENTS

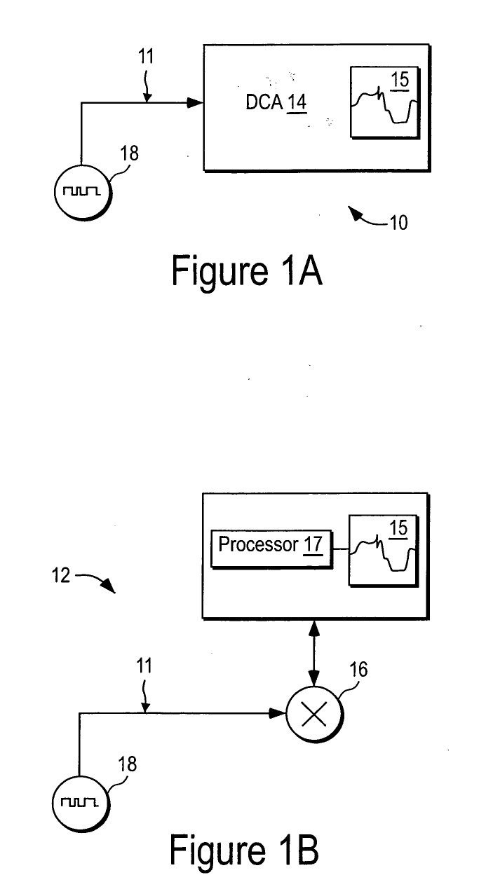

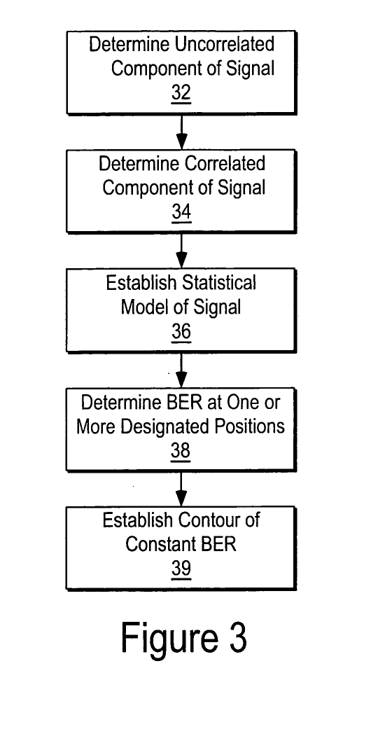

FIGS. 1A-1B show examples of sampling systems 10, 12 receiving signals 11. In FIG. 1A, the sampling system 10 includes a digital communications analyzer (DCA) 14, such as an AGILENT TECHNOLOGIES, INC. model 86100C DIGITAL COMMUNICATIONS ANALYZER. A system 30 for characterizing the signal 11 (shown FIG. 3) according to embodiments of the present invention is implemented using a DCA 14, typically via hardware or software that interfaces with the DCA 14. In FIG. 1B, the system 30 for characterizing the signal 11 is implemented via a sampler 16 and a processor 17 in signal communication with the sampler 16. The processor 17 processes samples that are acquired by the sampler 16 to characterize the signal 11 according to the system 30.

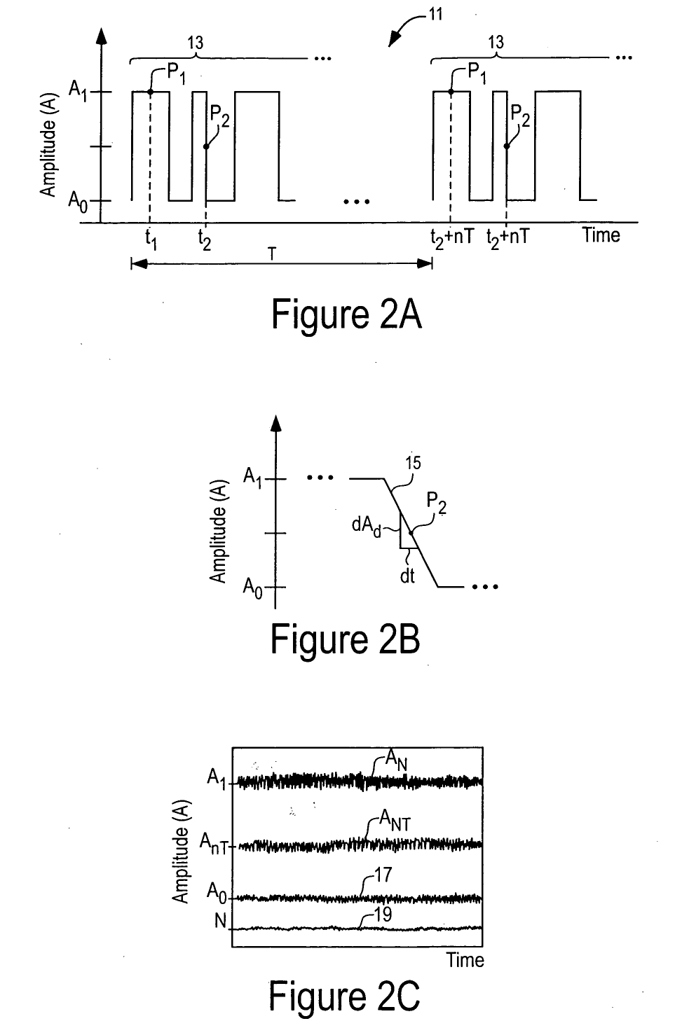

FIG. 2A shows one example of a signal 11 suitable for characterization by the system 30 according to embodiments of the present invention. In this example, the signal 11 is a digital signal that includes a repetitive pattern of bits (hereinafter bit pattern 13). In alternative examples, the signal 11 is an analog signal, or any other type of signal or waveform that has one or more patterns, portions or other attributes that are repetitive. The bit pattern 13 shown in FIG. 2A is repetitive and has a pattern length T. The bits are encoded in logic states, or logic levels designated as logic “0” or logic “1”. The logic 0 is represented as a first amplitude level A₀ in the signal 11, whereas the logic 1 is represented as a second amplitude level A₁ that is higher than the first amplitude level A₀. The signal 11 is typically provided by a pattern generator, data source or other signal source 18 (shown in FIGS. 1A-1B), and can be filtered, equalized or otherwise modified by a communication channel within a communication system, or by other types of components or signal conditioners.

FIG. 3 shows a flow diagram of the system 30 for characterizing a signal 11 according to the embodiments of the present invention. For the purpose of illustration, the system 30 is presented in the context of the DCA 14 shown in FIG. 1A, and the signal 11 is designated to be a digital signal that has a bit pattern 13 that is repetitive. Step 32 of the system 30 includes determining an uncorrelated component of the signal 11. The uncorrelated component includes amplitude and timing fluctuations of the signal 11 that are not correlated with the bit pattern 13 of the signal 11. Step 34 includes determining a correlated component of the signal 11. The correlated component includes amplitude and timing fluctuations of the signal 11 that are correlated with the bit pattern 13 of the signal 11.

The uncorrelated component of the signal 11, determined in step 32, includes a random uncorrelated amplitude component A_{UR} of the signal (hereinafter “amplitude component A_{UR}”) and a random uncorrelated timing, or jitter, component J_{UR} of the signal (hereinafter “jitter component J_{UR}”). The amplitude component Au and jitter component J_{UR} are typically determined by pattern locking the DCA 14 and then triggering the DCA 14 to acquire two sets of samples at two corresponding designated positions P1, P2 within the bit pattern 13, as shown in the example of the signal 11 of FIG. 2A. A first set of samples, set A_{N}, includes samples at positions P1 acquired at times t₁+nT, where t₁ is a designated time position within the bit pattern, n is a set of integers and T is the pattern length of the bit pattern 13. The designated time position ti corresponds to the position P1 within the bit pattern 13, at which the time derivative dA_{CD}/dt of a deterministic correlated amplitude component A_{CD} of the signal 11 equals zero. Alternatively, the position P1 is selected to be at a location on the signal 11 where the magnitude of the time derivative dA_{CD}/dt is at a minimum, or at a relatively low value. The positions P1 within the bit pattern 13 typically occurs where the signal 11 is nominally at the amplitude level A₀ or at the amplitude level A₁. In the example shown in FIG. 2A, the set A_{N} includes samples of the signal 11 that are acquired at positions in the bit pattern 13 wherein the signal 11 is nominally at the amplitude level A₁. In alternative examples (not shown), the set A_{N} includes samples that are acquired at positions in the bit pattern 13 wherein the signal 11 is nominally at the amplitude level A₀.

A second set of samples, set A_{NT}, includes samples at positions P2, acquired at times t₂+nT, where t₂ is a designated time position within the bit pattern 13, n is a set of integers and T is the pattern length of the bit pattern 13. The designated time position t₂ corresponds to the position P2 within the bit pattern 13 at which the magnitude of the time derivative dA_{CD}/dt of a deterministic correlated amplitude component A_{CD} of the signal 11 is at a maximum or at a relatively high level. This condition typically occurs at amplitude transitions of the signal 11. In the example shown in FIG. 2A, the set A_{NT} includes samples acquired at positions P2 that are on a transition 15 of the signal 11 from the amplitude level A₁ to the amplitude level A₀. In an alternative example (not shown), the set A_{NT} includes samples acquired at positions that are on a transition of the signal 11 from the amplitude level A₀ to the amplitude level A₁.

FIG. 2C shows examples of the samples in the set A_{N}. In one example, the set A_{N} includes samples that are acquired when the signal 11 is nominally at the amplitude level Aₗ. In another example, the set A_{N} includes samples 17 that are acquired when the signal 11 is nominally at the amplitude level A₀. To illustrate the noise level N in the DCA 14, FIG. 2C shows samples 19 that are acquired when no signal 11 is applied to the DCA 14. FIG. 2C also shows an example where the samples in the set A_{NT} are acquired on the transition 15 between the amplitude level A₁ and the amplitude level A₀.

In FIG. 2C, amplitude noise that is present on the signal 11 is shown as being dependent on the amplitude A of the signal 11. The amplitude noise on the samples in the set A_{N} is shown as greater than the amplitude noise on the samples 17, indicating that amplitude noise increases with increasing amplitude A of the signal 11. This dependence of the amplitude noise on the amplitude A of the signal 11 is typical of signals 11 within optical systems that include laser transmitters, optical amplifiers or other nonlinear devices or components. Amplitude noise that is dependent on the amplitude A can be accommodated by establishing a function, look-up table, or other characterization of the amplitude dependence and expressing the amplitude component A_{UR} as a function of amplitude A according to the established characterization. The amplitude noise present on the signal 11 can also be independent of the amplitude A of the signal 11. When the amplitude noise is independent of the amplitude A of the signal 11, noise A_{NTR} of the samples in the set A_{NT}, and the amplitude component A_{UR} and the jitter component J_{UR} are Gaussian, the noise A_{NTR} can be expressed in terms of the amplitude component A_{UR} and the jitter component J_{UR} according to the relationship:
A_{NTR}=A_{UR}+k J_{UR} (1)
where k represents the slope of the signal 11 at the transition at which the samples in the set A_{NT} are acquired. The slope represented by k has units of volts/sec, for example, and results in conversion between a timing noise and amplitude noise at the transition 15 at which the samples A_{NT} are acquired. Typically, k is determined by the slope of a line that can be fit to samples along the designated transition 15 of the signal 11, or by the time derivative dA_{CD}/dt of a deterministic correlated amplitude component A_{CD} of the signal 11.

However, any suitable graphical technique, calculation, or estimation of the slope of the designated transition 15 at the point P2 can be used to determine k. In the relationship (1), the amplitude component A_{UR} and the noise A_{NTR} can each be represented by the standard deviation of the respective Gaussian representations of the noise of the samples in the sets A_{N}, A_{NT}, respectively. The jitter component J_{UR} can then be acquired from the amplitude component A_{UR}, the noise A_{NTR} and k, via the relationship (1).

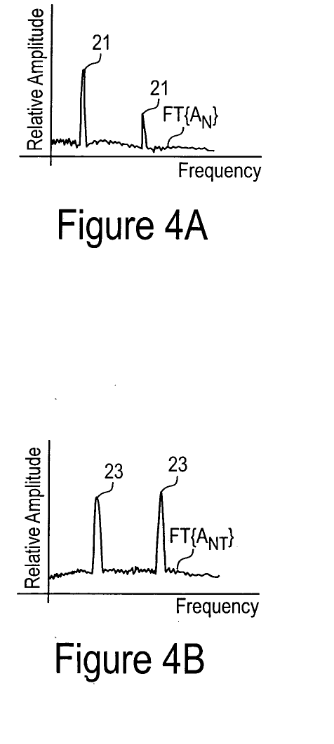

When the signal 11 has an amplitude component A_{NR} and noise A_{NTR} that are not Gaussian, the amplitude component A_{NR} and the noise A_{NTR} can be determined by calculating, computing, or otherwise obtaining the Fourier Transform of the set A_{N}, indicated as FT{A_{N}}, and the Fourier Transform of the set A_{NT}, indicated as FT{A_{NT}}. Examples of the Fourier Transform FT{A_{N}} and the Fourier Transform FT{A_{NT}} are shown in FIG. 4A and FIG. 4B, respectively. Signal peaks 21, 23 or other deterministic attributes in each of the resulting Fourier Transforms FT{A_{N}}, FT{A_{NT}} are then neutralized by replacing the signal peaks 21, 23 with an average value of the resulting points in the corresponding Fourier Transforms FT{A_{N}}, FT{A_{NT}}. However, the Fourier Transforms FT{A_{N}}, FT{A_{NT}} are alternatively neutralized by any suitable technique that reduces the effects or presence of the deterministic attributes or components of the Fourier Transforms FT{A_{N}}, FT{A_{NT}}. Once the Fourier Transforms FT{A_{N}}, FT{A_{NT}} are neutralized, the amplitude component A_{UR} is determined from the integral of the Fourier Transform FT{A_{N}}, and the noise A_{NTR} is determined from the integral of the Fourier Transform FT{A_{NT}}. The jitter component J_{UR} is then determined from the amplitude component A_{UR}, the noise A_{NTR}, and k via the relationship:
A_{NTR}=(A_{UR}²+k²J_{UR}²)^{1/2} (2).

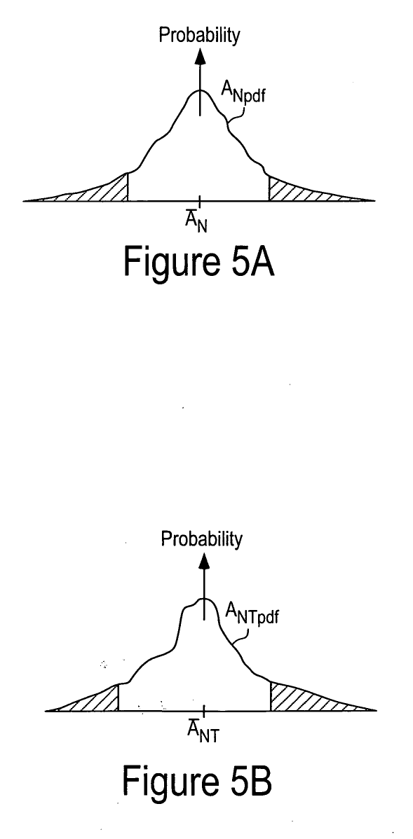

Determining the uncorrelated component of the signal 11 in step 32 of the system 30 also includes determining a deterministic uncorrelated amplitude component A_{UD} (hereinafter “amplitude component A_{UD}”) and a deterministic uncorrelated timing, or jitter, component J_{UD} (hereinafter “jitter component J_{UD}”) of the signal 11. In one example, the amplitude component A_{UD} and the jitter component J_{UD} are established using histograms or probability density functions established for each of the sets A_{N}, A_{NT}. A probability density function of the set A_{N}, shown in FIG. 5A as A_{Npdf}, depicts the probability of occurrence of the difference of the represented amplitudes of each sample in the set A_{N} from the mean \overline{A_{N}} of the set A_{N}. A probability density function of the set A_{NT}, shown in FIG. 5B as A_{NTpdf}, depicts the probability of occurrence of the difference of the represented amplitudes of each sample in the set A_{NT} from the mean \overline{A_{NT}} of the set A_{NT}.

The probability density function A_{Npdf} is truncated at low probabilities due to the finite number of samples in the set A_{N}. At these low probabilities, for example the probabilities that are too low to be represented by the finite number of samples in the set A_{N}, the probability density function A_{Npdf} can be represented by the convolution A_{UR}*A_{UD} using a dual-Dirac model. The dual-Dirac model enables the probability density function A_{Npdf} to be extrapolated to accommodate the low probabilities (indicated by hatching in FIG. 4A). The dual-Dirac model establishes a cumulative distribution of the probability density function A_{Npdf} and adjusts a spacing, or offset, between two Dirac delta functions to result in a cumulative distribution function of the convolution A_{UR}*A_{UD} matching a cumulative distribution function of the probability density function A_{Npdf}. Since the amplitude component A_{UR} is known, the amplitude component A_{UD} can be determined at the low probabilities from the matching of the probability density function A_{Npdf}, as extrapolated for low probabilities, to the convolution A_{UR}*A_{UD}. Dual-Dirac modeling is known in the art and is described for example in Fibre Channel-Methodologies for Jitter and Signal Quality Specification—MJSQ, T11/Project 1316-DT/Rev 14, June 2004.

At low probabilities, for example probabilities that are too low to be represented by the finite number of samples in the set A_{NT}, the probability density function A_{NTpdf}, can be represented by the convolution A_{UR}*A_{UD}*kJ_{UR}*kJ_{UD} using a dual-Dirac model. The dual-Dirac model enables the probability density function A_{NTpdf}, which is truncated at low probabilities due to the finite number of samples in the set A_{NT}, to be extrapolated to accommodate the low probabilities (indicated by hatching in FIG. 4B) that are not present in the probability density function A_{NTpdf}. The dual-Dirac model establishes a cumulative distribution function of the probability density function A_{NTpdf} A spacing, or offset, between two Dirac delta functions is adjusted so that a cumulative distribution function of the convolution A_{UR}*A_{UD}*kJ_{UR}*kJ_{UD} matches the cumulative distribution of the probability density function A_{NTpdf}. Since the terms A_{UR}, J_{UR} and A_{UD} are known, once the probability density function A_{NTpdf} is extrapolated to accommodate low probabilities, the amplitude component A_{UD} can be determined at the low probabilities from the matching of the probability density function A_{NTpdf}, as extrapolated, to the convolution A_{UR}*A_{UD}*kJ_{UR}*kJ_{UD}.

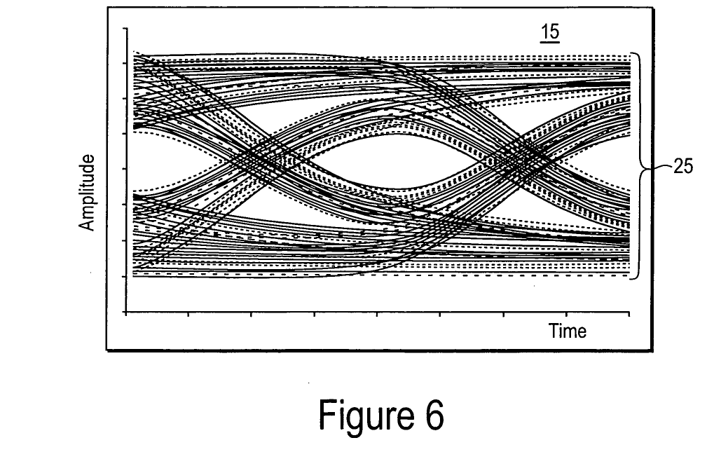

Determining the correlated component of the signal 11 in step 34 of the system 30 includes determining a deterministic correlated amplitude component A_{CD} of the signal 11 (hereinafter “amplitude component A_{CD}”) and a deterministic correlated timing, or jitter, component J_{CD} of the signal 11 (hereinafter “jitter component J_{CD}”). The amplitude component A_{CD} and the jitter component J_{CD} can be determined by pattern locking the D_{CA} 14 and then varying the trigger of the D_{CA} 14 to acquire sequential or successive equivalent-time samples of designated bits within the signal 11. The D_{CA} 14 is set to perform a running average of the equivalent-time samples acquired for each of the designated bits to eliminate or substantially reduce the amplitude and timing fluctuations of the signal 11 that are not correlated to the bits within the signal 11. This pattern locking, equivalent time sampling, and averaging of the acquired samples of the designated bits within the signal 11 provide the amplitude component A_{CD} and the jitter component J_{CD} for a variety of designated bits within the signal 11. The resulting averaged samples form a family of averaged eye traces 25 of designated bits in the signal 11 that can be time-shifted and superimposed on a display 15. FIG. 6 shows one example of a family of averaged eye traces 25 overlayed and displayed within a time duration of approximately a bit within the signal 11. In one example, the family of averaged eye traces 25 can be obtained by acquiring samples of the signal 11 with the model 86100B DIGITAL COMMUNICATION ANALYZER set in an eye mask mode. The acquired samples are then appropriately time-shifted to superimpose the averaged eye traces to form the family of averaged eye traces 25.

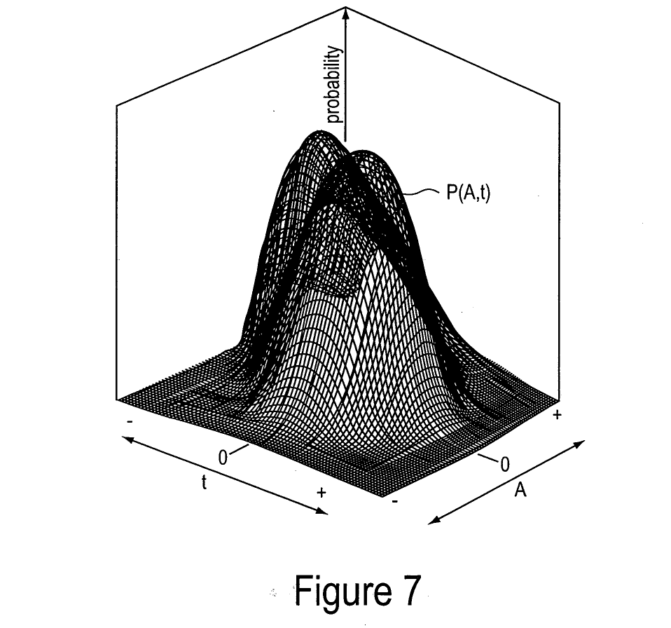

Step 36 of the system 30 (shown in FIG. 3) includes establishing a statistical model Px of the signal 11. The statistical model Px indicates deviations from the correlated component of the signal 11 that are due to the uncorrelated component of the signal 11. Typically, establishing the statistical model includes applying a three-dimensional probability density function P (shown in FIG. 7), based on the uncorrelated components A_{UR}, J_{UR}, A_{UD}, J_{UD}, to the correlated components A_{CD}, J_{CD}. In one example the probability density function P is a function of amplitude A and time t, and is represented as P(A,t) according to the relationship:
P(A, t)=C₁(e^{-(A-\overline{A}-A}_{^{UD}}^{/2)}^{²}⁾+e^{-(A+\overline{A}-A}^{_{UD}}^{/2)}^{²}^{/(2 A}_{^{UR}}^{²}₎)·(e^{-(t-J}_{^{UD}}^{/2)}^{²}^{/(4 J}_{^{UR}}^{²}⁾+e^{-(t+J}_{^{UD}}^{/2)}^{²}^{/(4 J}_{^{UR}}^{²}⁾)
where \overline{A} is the mean of the represented amplitudes A of the samples in the set A_{N}, and C₁ is a normalizing constant such that

$${C}_{1} {\int }_{∞}^{∞} {\int }_{∞}^{∞} P ( A , t ) ⅆ A ⅆ t = 1.$$

In one example, applying the probability density function P(A,t) to the correlated components of the signal 11 includes convolving the probability density function P(A,t) with the family of averaged eye traces 25. In another example, applying the probability density function P(A,t) to the correlated components of the signal 11 includes evaluating the probability density function P(A,t) at each of the amplitude and time positions (A,t) in the family of averaged eye traces 25. The statistical model Px(A,t) at each position (A,t) is then established from the summation of the contributions, at the amplitude and time position (A,t), from the evaluated probability density functions P(A,t).

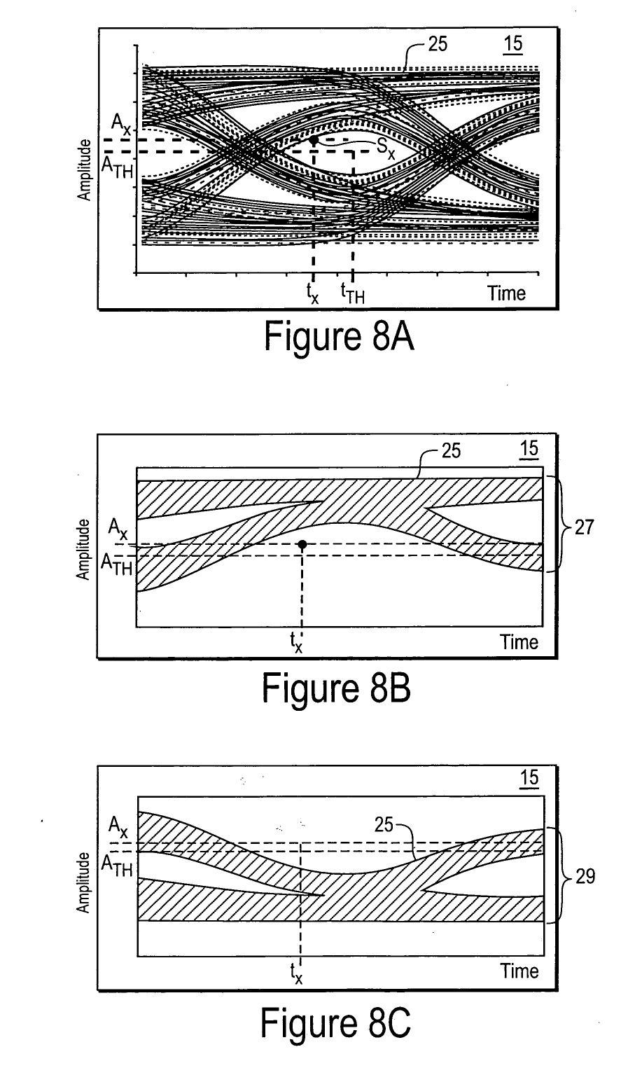

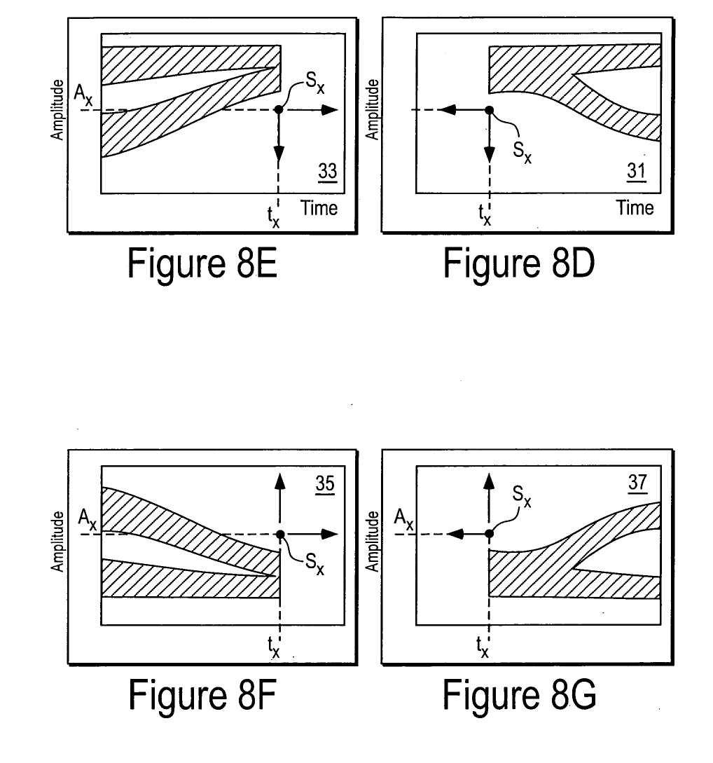

In optional step 38, a bit error ratio (BER) is determined at one or more designated positions Sₓ in an amplitude-time plane from the statistical model Pₓ(A,t) of the signal 11. FIGS. 8A-8G illustrate features of one example of a method for determining the BER at a designated position Sₓ having coordinates amplitude Aₓ and a time tₓ in the amplitude-time plane. In FIG. 8A, the position Sₓ is shown relative to averaged eye traces.

In one step of the method, averaged eye traces within the family of averaged eye traces 25 are sorted into two groups, as shown in FIGS. 8B and 8C. One group 27 (shown in FIG. 8B) includes the averaged eye traces that represent a logic 1 in the signal 11. Another group 29 (shown in FIG. 8C) includes the averaged eye traces that represent a logic 0 in the signal 11. The sorting is typically achieved by picking a threshold amplitude level A_{TH}, at a time position t_{TH} that is centered within the “eye” formed by the family of averaged eye traces 25 shown in FIG. 8A. The threshold amplitude level A_{TH} is selected to minimize the occurrence of a logic 0 in those averaged eye traces 25 that are above the threshold amplitude level A_{TH}, and to minimize the occurrence of a logic 1 in those averaged eye traces that are below the threshold amplitude level A_{TH}.

In addition to sorting the family of averaged eye traces 25 into the two groups 27, 29 shown in FIGS. 8B-8C, the method for determining BER includes further sorting each of the two groups 27, 29 into two subgroups, to yield the four quadrants 31, 33, 35, 37 shown in FIGS. 8D-8G. The upper quadrants 31, 33 shown in FIGS. 8D and 8E separate the averaged eye traces in the group 27 at the coordinate of time tₓ of the position Sₓ. The lower quadrants 35, 37 that are shown in FIGS. 8F and 8G separate the averaged eye traces in the group 29 at the coordinate of time tₓ of the position Sₓ.

The method for determining BER at the position Sₓ also includes evaluating the probability density function P(A,t) at the amplitude and time positions (A,t) of the averaged eye traces in each of the quadrants 31, 33, 35, 37. Then, the contributions from the evaluated probability density functions P(A,t) are summed at each amplitude and time position (A,t) to establish statistical models P₁(A,t), P₂(A,t), P₃(A,t), and P₄(A,t) of the signal 11 corresponding to each of the quadrants 31, 33, 35, 37. The statistical model P₁(A,t) corresponding to the quadrant 31, and the statistical model P₂(A,t) corresponding to the quadrant 33 are used to determine the probability of error due to a logic “1” being mistaken for a logic “0”. The statistical model P₃(A,t) corresponding to the quadrant 35, and the statistical model P₄(A,t) corresponding to the quadrant 37 are used to determine the probability of error due to a logic “0” being mistaken for a logic “1”. The statistical models P₂(A,t), P₃(A,t) are used to determine the probability of error for a logic “1” being mistaken for a logic “0”, or a logic “0” being mistaken for a logic “1”, due to late transitions between logic states in the signal 11. The statistical models P₁(A,t), P₄(A,t) are used to determine the probability of error for a logic “1” being mistaken for a logic “0”, or a logic “0” being mistaken for a logic “1”, due to early transitions between logic states in the signal 11.

The contribution to the BER from the statistical models P₁(A,t), P₂(A,t), P₃(A,t), and P₄(A,t) of the signal 11, corresponding to the quadrants 31, 33, 35, 37, is determined by a two-dimensional integration of the statistical models along the directions shown by the arrows (shown in FIGS. 8D-8G), in each corresponding quadrants. The BER at the designated point Sₓ is then determined as the sum of the integrals that are indicated by the relationship:

$$\begin{matrix}{BER}_{ Sx} = {C}_{2} ( {\int }_{{A}_{TH}}^{∞} {\int }_{{t}_{TH}}^{∞} {P}_{3} ( A , t ) ⅆ A ⅆ t + \\ {\int }_{{A}_{TH}}^{∞} {\int }_{- ∞}^{{t}_{TH}} {P}_{4} ( A , t ) ⅆ A ⅆ t + \\ {\int }_{- ∞}^{{A}_{TH}} {\int }_{{t}_{TH}}^{∞} {P}_{1} ( A , t ) ⅆ A ⅆ t + {\int }_{- ∞}^{{A}_{TH}} {\int }_{- ∞}^{{t}_{TH}} {P}_{2} ( A , t ) ⅆ A ⅆ t )\end{matrix}$$

(3), where C₂ is a normalizing constant, such that

$${C}_{2} {\int }_{- ∞}^{∞} {\int }_{- ∞}^{∞} P ( A , t ) ⅆ A ⅆ t = 1.$$

According to alternative embodiments of the present invention, the integral relationship for the BER_{Sx} can be approximated by a summation of discrete representations of the appropriate elements of the integrals in the relationship (3).

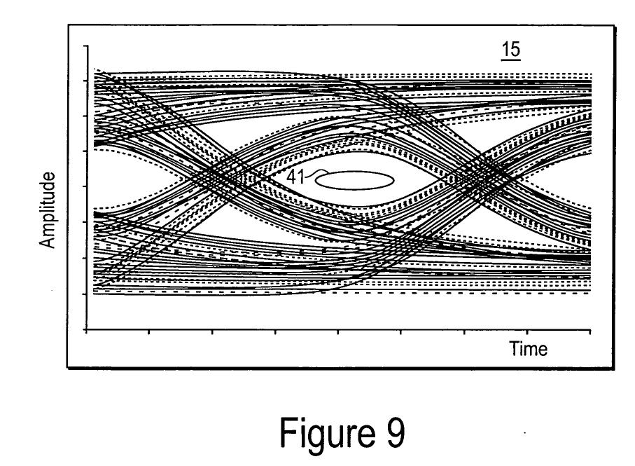

In optional step 39 of the system shown in FIG. 3, contours 41 where the BER of the signal 11 has a constant value are established. The contours 41 of constant BER are typically established by evaluating the BER at a variety of positions Sₓ in the amplitude-time plane and then selecting the coordinates of the amplitudes Aₓ and times tₓ of those positions Sₓ that have a predesignated BER value. The selected coordinates that correspond to the designated BER value can be used to construct a contour 41 of constant BER. The constructed contour 41 of constant BER can be superimposed on a display 15 of a standard eye diagram of the signal 11 (as shown in FIG. 9). The contour 41 of constant BER can also be presented on a display 15 indicating any other attributes or representations of the signal 11. According to alternative embodiments of the present invention, multiple contours 41 of constant BER for multiple designated BER values are displayed.

In one example application of the system 30, the signal 11 that is characterized is a signal within a communication system that is equalized or otherwise processed, for example to reduce inter-symbol interference (ISI) or to reduce BER. The equalization or processing can be applied to modify the correlated component of the signal 11 determined in step 34 of the system 30, and the BER can be determined from the modified correlated component of the signal 11, and the uncorrelated component of the signal 11 determined in step 32, according to the relationship (3). Alternatively, the equalization or processing can be applied to modify the correlated component of the signal 11 determined in step 34 of the system 30. An estimate or approximation of the effect of the equalization or processing on the uncorrelated component of the signal 11 determined in step 32 can also be established. The BER can then be determined from the modified correlated component of the signal 11 and the estimated or approximated uncorrelated component of the signal 11, according to the relationship (3).

In another example application of the system 30, the statistical model Px(A,t) of the signal 11 can be used to predict the statistical behavior of the signal 11 at any of a variety of positions Sₓ in the amplitude-time plane.

While the embodiments of the present invention have been illustrated in detail, it should be apparent that modifications and adaptations to these embodiments may occur to one skilled in the art without departing from the scope of the present invention as set forth in the following claims.

1. A system for characterizing amplitude and timing attributes of a signal, comprising:
determining an uncorrelated component of the signal;
determining a correlated component of the signal; and
establishing a statistical model of the signal based on the uncorrelated component and the correlated component of the signal.

2. The system of claim 1 wherein the uncorrelated component of the signal is uncorrelated to one or more bit patterns within the signal.

3. The system of claim 1 wherein the correlated component of the signal is correlated to one or more bit patterns within the signal.

4. The system of claim 2 wherein the correlated component of the signal is correlated to the one or more bit patterns within the signal.

5. The system of claim 1 wherein the uncorrelated component of the signal includes a random uncorrelated component and a deterministic uncorrelated component.

6. The system of claim 2 wherein the uncorrelated component of the signal includes a random uncorrelated component and a deterministic uncorrelated component.

7. The system of claim 3 wherein the uncorrelated component of the signal includes a random uncorrelated component and a deterministic uncorrelated component.

8. The system of claim 5 wherein the random uncorrelated component includes a random uncorrelated amplitude component and a random uncorrelated timing component.

9. The system of claim 5 wherein the deterministic uncorrelated component includes a deterministic uncorrelated amplitude component and a deterministic uncorrelated timing component.

10. The system of claim 8 wherein the deterministic uncorrelated component includes a deterministic uncorrelated amplitude component and a deterministic uncorrelated timing component.

11. The system of claim 1 wherein the statistical model of the signal indicates deviation from the correlated component of the signal due to the uncorrelated component of the signal.

12. The system of claim 11 wherein establishing a statistical model of the signal includes applying a three-dimensional probability density function to the correlated signal component.

13. The system of claim 11 further comprising determining a BER at one or more designated amplitude and time positions based on the established statistical model.

14. The system of claim 11 further comprising establishing one or more contours of constant BER.

15. A system for characterizing a signal having a repetitive attribute, comprising:
determining a component of the signal that is uncorrelated to the repetitive attribute of the signal;
establishing a probability density function based on the uncorrelated component;
determining a component of the signal that is correlated to the repetitive attribute of the signal; and
applying the established probability density function to the correlated component to establish a statistical model of the signal.

16. The system of claim 15 wherein the component of the signal that is uncorrelated to the repetitive attribute of the signal includes at least one of a random amplitude component, a random timing component, a deterministic amplitude component, and a deterministic timing component.

17. The system of claim 15 wherein the component of the signal that is correlated to the repetitive attribute of the signal includes at least one of a deterministic amplitude component and a deterministic timing component.

18. The system of claim 16 wherein the component of the signal that is correlated to the repetitive attribute of the signal includes at least one of a deterministic amplitude component and a deterministic timing component.

19. The system of claim 15 wherein the repetitive attribute of the signal includes one or more bit patterns within the signal.

20. The system of claim 19 further comprising determining a BER at one or more designated amplitude and time positions based on the established statistical model.
